(19) United States
(12) Patent Application Publication
(10) Pub. No.: US 2026/0202594 A1
(43) Pub. Date: Jul. 16, 2026

(54) DEVICE, SYSTEM, AND METHOD FOR PRODUCING A DEVICE

(71) Applicant: JENOPTIK Optical Systems GmbH, Jena (DE)

(72) Inventors: Helmut BERNITZKI, Jena (DE); Sven LAUX, Jena (DE); Jens LIEDER, Jena (DE); Paul SCHMITT, Jena (DE)

(73) Assignee: JENOPTIK Optical Systems GmbH, Jena (DE)

(21) Appl. No.: 19/136,175

(22) PCT Filed: Nov. 30, 2023
(86) PCT No.: PCT/EP2023/083727

§ 371 Date: Jun. 5, 2025

(30) Foreign Application Priority Data
Dec. 5, 2022 (DE) 10 2022 132 139.8

(51) Int. Cl. G02B 5/20; G02B 1/08; G02B 5/30

(52) U.S. Cl. CPC G02B 5/208; G02B 1/08; G02B 5/3083

(57) ABSTRACT

A device for at least partial reflection of electromagnetic radiation, comprising at least one base element, with a coating being arranged in at least portions of at least one surface of the base element. The coating comprising at least one layer of a first highly refractive material and at least one layer of a second highly refractive material.

The invention relates to a device for at least partial reflection of electromagnetic radiation having the features of independent claim 1, to a system comprising a device for at least partial reflection of electromagnetic radiation having the features of independent claim 10, and to a method of producing a device for at least partial reflection of electromagnetic radiation having the features of independent claim 11.

In order to influence the transmission, reflection and/or polarization properties of optical components, these are in many cases provided with optical coatings, with adaptation of the optical coatings to the manner of use of the optical component. For example, optical coatings may be provided for filtering of electromagnetic radiation or maximum reflection of electromagnetic radiation. Production of optical coatings, especially with the aim of achieving high-quality optical properties, for example a coating with maximum reflectance and/or low absorptivity, can be complex and costly.

It is therefore an object of the present invention to at least partly overcome at least one of the drawbacks described above. It is a particular object of the invention to provide an optical coating with high-quality optical properties in a simple and/or inexpensive manner. It is a particular object of the invention to provide an optical coating, preferably a broadband and low-scatter optical coating, having high reflectance and/or low absorptivity in a simple and/or inexpensive manner.

The above object is achieved by a device having the features of independent claim 1, by a system having the features of independent claim 10, and by a method having the features of independent claim 11. Further features and details of the invention will be apparent from the subsidiary claims, the description and the drawings. Features and details that are described in the context of the device of the invention are of course also applicable in the context of the system of the invention and/or in the context of the method of the invention and vice versa in each case, and so the disclosure relating to the individual aspects of the invention always relates, or may relate, to the other aspects of the invention.

The invention provides a device for at least partial reflection of electromagnetic radiation, comprising at least one base element, wherein a coating, especially a dielectric coating, is disposed in at least sections of at least one surface of the base element, wherein the coating comprises at least one layer of a first high refractive index material and at least one layer of a second high refractive index material, and wherein the first high refractive index material is different than the second high refractive index material.

In other words, what is envisaged within the scope of the invention is that a coating comprising at least two layers is disposed on a base element of a device of the invention.

This coating comprises at least one layer of a first high refractive index material and at least one layer of a second high refractive index material which is different than the first high refractive index material. With regard to the present invention, a combination of different high refractive index materials within a coating has been found to be particularly advantageous for achievement of high-quality optical properties of the coating, in particular for achievement of high reflectivity and/or low absorptivity of the coating.

It is conceivable within the scope of the invention that the at least one layer of a first high refractive index material is part of a layer stack, in particular a first layer stack. It may further be the case within the scope of the invention that the at least one layer of a second high refractive index material is part of a layer stack, in particular a second layer stack.

It is further conceivable that at least one layer of a first low refractive index material is part of a layer stack, in particular a first layer stack. It is also conceivable that at least one layer of a second low refractive index material is part of a layer stack, in particular a second layer stack.

A base element in the context of the present invention shall be considered to mean a carrier element or carrier material, at least sections of which are ensheathed with the coating. It may be the case within the scope of the invention that at least sections of at least one base element are formed from a low-absorption material. In particular, it is conceivable that at least sections of at least one base element are formed from a glass or polymer material, in particular a low-absorption quartz glass and/or a low-absorption borosilicate crown glass.

A high refractive index material in the context of the present invention shall be considered to mean a material having a refractive index of 1.7 or more than 1.7. A low refractive index material in the context of the present invention shall further be considered to mean a material having a refractive index of less than 1.7. The refractive index is the ratio of the wavelength of the electromagnetic radiation in vacuum to the wavelength of the electromagnetic radiation in the material in question.

The absorptivity of a coating indicates the proportion of the power of electromagnetic radiation incident on the coating that is absorbed by the coating. The reflectivity of a coating indicates the proportion of the power of electromagnetic radiation incident on the coating that is reflected by the coating.

In the context of the invention, the electromagnetic radiation may be radiation from the near-infrared region. In the context of the present invention, the near-infrared region shall be considered to mean a wavelength range between 780 nm and 3000 nm, preferably between 850 nm and 2000 nm, more preferably between 900 nm and 1500 nm. In particular, electromagnetic radiation may be electromagnetic radiation from the near-infrared region with a wavelength of 1070 nm and/or 1064 nm and/or 1030 nm.

It may alternatively be the case that the electromagnetic radiation is radiation from the ultraviolet (UV) region. In the context of the present invention, the UV region shall be considered to mean a wavelength range between 100 nm and 380 nm, preferably between 100 nm and 180 nm. It may further be the case that the electromagnetic radiation is deep ultraviolet radiation (DUV radiation), where the wavelength of the DUV radiation is 193 nm or 248 nm.

It may alternatively be the case that the electromagnetic radiation is radiation from the visible region. In the context of the present invention, the visible region shall be considered to mean a wavelength range between 380 nm and 790 nm, preferably between 400 nm and 600 nm. In particular, the radiation may be electromagnetic radiation having a wavelength of 532 nm. It may further be the case that the device is a mirror for at least partial reflection of electromagnetic radiation. It may in particular be the case here that the mirror is a mirror for at least partial reflection of light radiation, particularly preferably laser radiation. Such a use of a device of the invention has been found to be particularly advantageous in the context of the invention.

It is also conceivable in the context of the invention that the device is a filter for filtering of electromagnetic radiation. It may in particular be the case that a filter of the invention is usable or finds use in a lithography process, preferably in the context of DUV lithography and/or E-beam lithography.

It may be the case within the scope of the invention that at least one layer, in particular all layers, of the second high refractive index material, proceeding from the surface of the base element, is/are disposed on top of at least one layer, in particular on top of all layers, of the first high refractive index material.

In the context of the invention, it may be advantageous that the first high refractive index material has a greater refractive index than the second high refractive index material, where, in particular, the difference between the refractive index of the first high refractive index material and the refractive index of the second high refractive index material is at least 0.1. Such a difference in refractive indices resulted in particularly advantageous properties of the coating in the context of the present invention.

In the context of the invention, it is further conceivable that at least one layer encompassed by the coating has been generated by a CVD (chemical vapor deposition) method and/or a PA-CVD (plasma-assisted vapor deposition) method. It may additionally or alternatively be the case that at least one layer encompassed by the coating has been generated by vapor deposition (thermal evaporation) or a PVD (physical vapor deposition) method. Alternatively or additionally, it is conceivable that at least one layer encompassed by the coating has been generated by sputtering and/or atomic layer deposition. In the context of the invention, layer generation by evaporation or a PVD method has been found to be particularly advantageous, since this can achieve particularly cost-and time-efficient layer generation. Furthermore, the benefit is manifested that an inventive combination of different high refractive index materials, even in the case of exclusive layer generation by evaporation, can achieve a coating with particularly high-quality optical properties, in particular high reflectance and/or low absorptivity.

It is further conceivable in the context of the invention that the vapor deposition of at least one layer encompassed by the coating has additionally been ion-and/or plasma-assisted. It is conceivable in particular that at least all layers of a first high refractive index material and/or at least all layers of a first low refractive index material and/or at least all layers of a first layer stack are vapor-deposited with ion and/or plasma assistance. Alternatively or additionally, it is further conceivable that at least all layers of a second high refractive index material and/or at least all layers of a second low refractive index material and/or at least all layers of a second layer stack are vapor-deposited without ion and/or plasma assistance. In this way, it has been found in the context of the invention that a particularly low-absorption, broadband, low-scatter and at the same time highly reflective coating can be generated.

It may be the case within the scope of the invention that the coating comprises at least one first layer stack, the first layer stack comprising at least one layer of the first high refractive index material and at least one layer of a first low refractive index material. It is further conceivable that the first layer stack, in particular at least one or exactly one layer from the first layer stack, is disposed on a surface of the base element. It is also conceivable in the context of the invention that the layer of the first layer stack disposed on the surface of the base element is formed from the first high refractive index material. Alternatively, however, it may also be the case that the layer of the first layer stack disposed on the surface of the base element is formed from the first low refractive index material. It is also conceivable that the first layer stack comprises exclusively layers of the first high refractive index material and the first low refractive index material.

It is further conceivable with regard to the present invention that the number of layers of the first high refractive index material in the first layer stack is equal to the number of layers of the first low refractive index material in the first layer stack and/or the layers of the first high refractive index material and the layers of the first low refractive index material in the first layer stack are in an alternating arrangement. An alternating arrangement of high and low refractive index layers can achieve a particularly high reflection of the coating.

It is further conceivable that the coating has at least a second layer stack, the second layer stack comprising at least one layer of the second high refractive index material and at least one layer of a second low refractive index material. It is further conceivable that the second layer stack is disposed atop the first layer stack. In other words, it may be the case that at least one or exactly one layer, in particular the lowermost layer proceeding from a surface of the base element, of the second layer stack is disposed atop a layer, in particular atop the uppermost layer proceeding from the surface of the base element, of the first layer stack. It may also be the case that the lowermost layer of the second layer stack proceeding from a surface of the base element is formed from the second high refractive index material. Alternatively, however, it may also be the case that the lowermost layer of the second layer stack proceeding from a surface of the base element is formed from the second low refractive index material. It is further conceivable that the second layer stack comprises exclusively layers of the second high refractive index material and the second low refractive index material.

It may be the case within the scope of the invention that, at least one transition, in particular at all transitions, from one layer stack to a subsequent layer stack, one of the two layers of the respective layer stack that are adjacent, especially one on top of the other, is formed from a low refractive index material and the respective other layer is formed from a high refractive index material. The transition may preferably be a transition between a first and a second layer stack or a second and a third or a third and a fourth layer stack. In other words, it may be the case that, in a transition between two layer stacks that are adjacent, in particular one on top of the other, an alternating arrangement of high refractive index and low refractive index materials is maintained. In this way, it has been found that it was possible to achieve a particularly advantageous coating with regard to the optical properties of the device, in particular with regard to high reflectivity and low absorptivity.

For example, it may be the case with regard to a transition between the first and second layer stack that the uppermost layer of the first layer stack proceeding from a surface of the base element is formed from the first high refractive index material and the lowermost layer of the second layer stack proceeding from a surface of the base element, which is disposed atop the first layer stack, is formed from the second low refractive index material.

Alternatively, it is conceivable that the uppermost layer of the first layer stack proceeding from a surface of the base element is formed from the first low refractive index material and the lowermost layer of the second layer stack proceeding from a surface of the base element, which is disposed atop the first layer stack, is formed from the second high refractive index material. This can be applied analogously to transitions between other layer stacks. In this way, an alternating arrangement of high and low refractive index materials is ensured, even in the case of a transition between two layer stacks.

It is further conceivable with regard to the present invention that the number of layers of the second high refractive index material in the second layer stack is equal to the number of layers of the second low refractive index material in the second layer stack and/or the layers of the second high refractive index material and the layers of the second low refractive index material in the second layer stack are in an alternating arrangement.

It may be the case within the scope of the invention that a layer stack is a stack of at least two layers, where the layers of the layer stack are arranged one on top of another proceeding from a surface of the base element. An alternating arrangement of layers of different materials in the present context means an alternating arrangement. With regard to a first high refractive and first low refractive index material, for example, a layer of the first high refractive index material is followed by a layer of the first low refractive index material and a layer of the first low refractive index material is followed by a layer of the first high refractive index material. It may be the case within the scope of the invention that each layer stack comprises solely layers of a high refractive index material and layers of a low refractive index material.

It may also be the case within the scope of the invention that the coating comprises more than two, in particular at least three, preferably at least four or at least five, layer stacks, where the layer stacks are preferably arranged one on top of another proceeding from the surface of the base element. It may be the case within the scope of the invention that at least three layer stacks are provided, where at least one layer stack comprises at least one layer of a third high refractive index material and at least one layer of a third low refractive index material. At least one layer stack, in particular each layer stack, may have an alternating arrangement of layers of high refractive index and low refractive index materials.

It is also conceivable that the coating comprises a layer of a third high refractive index material as outer layer, where the third high refractive index material in particular is the same as the second high refractive index material. It may alternatively be the case that the coating comprises a layer of a third low refractive index material as outer layer, where the third low refractive index material in particular is the same as the second low refractive index material. An outer layer in the present context shall be considered to mean an outermost layer of the coating. In other words, the outer layer of the coating is the layer furthest away from the base element proceeding from the surface of the base element. The outer layer is also the layer hit first by electromagnetic radiation that hits the coating.

It may be the case within the scope of the invention that the outer layer is disposed atop a layer of a layer stack that is disposed beneath the outer layer in relation to the surface of the base element. It may be the case within the scope of the invention that, at the transition between the layer stack and the outer layer, an alternating arrangement of low refractive index materials and high refractive index materials is maintained.

It may further be the case within the scope of the invention that an alternating arrangement of low refractive index materials and high refractive index materials is interrupted at the transition between the outer layer and an outermost layer stack disposed beneath the outer layer proceeding from the surface of the base element. In other words, it may be the case that, when the layer of the respective layer stack disposed beneath the outer layer is formed from a low refractive index material, the outer layer is likewise formed from a low refractive index material. It may alternatively be the case that, when the layer of the respective layer stack disposed beneath the outer layer is formed from a high refractive index material, the outer layer is likewise formed from a high refractive index material. For example, it may be the case that, when the second layer stack ends with a layer of the second high refractive index material and an outer layer is arranged atop said layer, the outer layer is formed from a third high refractive index material. It may alternatively be the case that, when the second layer stack ends with a layer of the second low refractive index material and an outer layer is disposed atop said layer, the outer layer is formed from a third low refractive index material. An interruption of an alternating arrangement of high refractive index and low refractive index materials at a transition between the outermost layer stack and an outer layer showed the benefit of high reflection and low absorption of a coating.

Within the scope of the invention, it is optionally possible that the first high refractive index material and/or the second high refractive index material is a material from the group of the following:
aluminum oxide (Al2O3),
hafnium oxide (HfO2),
yttrium oxide (Y2O3),
scandium oxide (Sc2O3),
cerium dioxide (CeO2),
tantalum(V) oxide (Ta2O5),
niobium(V) oxide (Nb2O5),
zirconium dioxide (ZrO2),
titanium dioxide (TiO2),
mixed oxide of silicon dioxide and aluminum oxide (SiO2:Al2O3),
mixed oxide of zirconium dioxide and hafnium oxide (ZrO2:HfO2),
silicon (Si),
silicon nitride (SIN),
silicon monoxide (SiO).

In particular, it is conceivable that the first high refractive index material is Ta2O5, TiO2, Nb2O5 or CeO2 and/or the second high refractive index material is HfO2, ZrO2 or ZrO2:HfO2. Such a material selection has been found to be particularly advantageous with regard to the generation of a broadband and low-scatter optical coating with high reflectivity and/or low absorptivity.

It may further be the case within the scope of the invention that the first low refractive index material and/or the second low refractive index material is a material from the group of the following:
silicon dioxide (SiO2),
mixed oxide of silicon dioxide and aluminum oxide (SiO2: Al2O3),
nanoporous SiO2,
magnesium fluoride (MgF2),
aluminum fluoride (AlF3),
cryolite (Na3AlF6).

In particular, it is conceivable that the first low refractive index material is SiO2 and/or that the second low refractive index material is SiO2. Such a material selection has been found to be particularly advantageous with regard to the generation of a broadband and low-scatter optical coating with high reflectivity and/or low absorptivity.

With regard to the present invention, it is conceivable that at least one layer encompassed by the coating takes the form of a quarter-wave layer (λ/4 layer). The formation of at least one layer as a λ/4 layer may be, relative to an electromagnetic radiation wavelength, in the range of 300 nm to 3000 nm, in particular in the range of 900 nm to 1500 nm. A λ/4 layer in the present context shall be considered to mean a layer having an optical layer thickness of ¼ of the addressed wavelength of an electromagnetic radiation. The optical layer thickness is found from the product of the geometric layer thickness with the refractive index of the layer material. The formation of individual or all layers of a coating of the invention can reduce the number of layers required in total for achievement of high-quality optical properties, in particular a high reflectivity with simultaneously high bandwidth.

It may be the case within the scope of the invention that the first layer stack has greater absorptivity than the second layer stack. This has been found to be advantageous in terms of the generation of a highly reflective and at the same time low-absorption coating.

It is further conceivable that the coating, in relation to incident electromagnetic radiation, especially electromagnetic radiation from the near-infrared region, has a reflectance of at least 98%, in particular at least 99%, preferably at least 99.5%, more preferably at least 99.9%, and/or an absorptivity of less than 20 ppm, in particular less than 10 ppm, preferably less than 2 ppm, more preferably less than 1.5 ppm. In this context, it may be the case that the electromagnetic radiation is incident on the coating at an angle between 0° and 45°. As already elucidated, absorptivity is a dimensionless (relative) figure. The unit ppm (parts per million) should be considered here to be an auxiliary unit of measurement or to represent the factor of 10⁻⁶ (comparable to the factor of 10⁻² for percent). A coating having the stated properties has been found to be particularly advantageous in particular in relation to the use of a device of the invention as a mirror for at least partial reflection of electromagnetic radiation.

An advantageous working example of the present invention is manifested in a coating comprising a first layer stack, wherein the first layer stack comprises in each case 12 layers of the first high refractive index material and a first low refractive index material, wherein the layers of the first high refractive index material and the layers of the first low refractive index material in the first layer stack are in an alternating arrangement. It may additionally or alternatively be the case that the coating comprises a second layer stack, wherein the second layer stack, proceeding from a surface of the base element, is disposed, in particular directly, above the first layer stack or atop the first layer stack, and the second layer stack in each case comprises 6 layers of the second high refractive index material and a second low refractive index material, wherein the layers of the second high refractive index material and the layers of the second low refractive index material in the second layer stack are in an alternating arrangement. It may further be the case that the lowermost layer of the first layer stack proceeding from a surface of the base element is formed from the first high refractive index material and/or an alternating arrangement of high refractive index materials and low refractive index materials is maintained even at the transition between the first and second layer stacks. It is further conceivable that such a coating comprises an outer layer, wherein the outer layer is disposed atop the second layer stack and is formed from a third low refractive index material, where the third low refractive index material is in particular the same as the second low refractive index material. With regard to such a coating, a particularly high reflectivity with simultaneously low absorption losses has been shown.

It may also be the case within the scope of the invention that a device of the invention, in particular a device as claimed in any of claims 1 to 9, has been produced by a method of the invention, in particular a method as claimed in any of claims 11 to 16.

The above object is also achieved by a system of the invention comprising at least one device for at least partial reflection of electromagnetic radiation as claimed in any of claims 1 to 9 and at least one emission unit for emission of electromagnetic radiation, in particular electromagnetic radiation in the near-infrared region, wherein, in particular, the emission unit is arranged relative to the device such that the electromagnetic radiation emitted by the emission unit at least partly hits the coating of the device, preferably at an angle between 0° and 45°.

It may further be the case that the device is arranged relative to the emission unit such that the electromagnetic radiation first hits the outermost layer with respect to the surface of the base element, in particular an outer layer, of the coating of the device. With regard to a system according to the invention, the advantages that arise are the same that have already been described with regard to a device of the invention.

The above object is further achieved by a method of the invention for producing a device for at least partial reflection of electromagnetic radiation, in particular as claimed in any of claims 1 to 9. The method comprises applying a coating to a base element of the device, wherein the coating is applied by also performing at least the following steps, in particular in the sequence specified:
a) applying a layer of a first high refractive index material, where the first high refractive index material is preferably a material from the group of Al2O3, HfO2, Y2O3, Sc2O3 , CeO2, Ta2O5, Nb2O5, ZrO2, TiO2, SiO2:Al2O3, ZrO2:HfO2, Si, SiN, SiO, in particular in that the first high refractive index material is Ta2O5, TiO2, Nb2O5 or CeO2,
c) applying a layer of a second high refractive index material, where the second high refractive index material is a material from the group of Al2O3, HfO2, Y2O3, Sc2O3, CeO2, Ta2O5, Nb2O5, ZrO2, TiO2, SiO2:Al2O3, ZrO2:HfO2, Si, SiN, SiO, in particular in that the second high refractive index material is HfO2, ZrO2 or ZrO2:HfO2,
   wherein the first high refractive index material is different than the second high refractive index material and wherein, in particular, the first high refractive index material has a greater refractive index than the second high refractive index material.

A method of the invention enables simple and rapid production of a coating with high-quality optical properties. In particular, a method of the invention enables time-and cost-efficient production of a broadband and low-scatter optical coating having high reflectivity and/or low absorptivity. Furthermore, the benefits that arise with regard to a method of the invention are the same as have already been described with regard to a device of the invention and/or a system of the invention. It may be the case within the scope of the invention that individual steps of a method of the invention are executed repeatedly or more than once.

In the context of the invention, it may be advantageous that at least the following step is performed additionally, especially before or after step a):
b) applying at least one layer of a first low refractive index material, where the first low refractive index material is preferably a material from the group of SiO2, SiO2:Al2O3, nanoporous SiO2, MgF2, AlF3, Na3AlF6.

In particular, it may be the case in this context that the first low refractive index material is SiO2.

In the context of the invention, it is further conceivable that at least the following step is performed additionally, in particular before or after step c):
d) applying at least one layer of a second low refractive index material, where the second low refractive index material is preferably a material from the group of SiO2, SiO2:Al2O3, nanoporous SiO2, MgF2, AlF3, Na3AlF6, especially in that the second low refractive index material is SiO2.

In particular, it may be the case in this context that the second low refractive index material is SiO2.

It may be the case within the scope of the invention that at least the following step is performed additionally, in particular after step d):
e) applying an outer layer of a third high refractive index material, where, in particular, the third high refractive index material is the same as the second high refractive index material, or applying an outer layer of a third low refractive index material, where, in particular, the third low refractive index material is the same as the second low refractive index material.

It may be the case within the scope of the invention that step e) forms a last step in relation to the formation of the coating. In other words, the outer layer applied in step e) may be the last layer of the coating or the outermost layer of the coating in relation to a surface of the base element.

It is also conceivable that at least one layer encompassed by the coating is applied by a CVD (chemical vapor deposition) and/or a PA-CVD (plasma-assisted vapor deposition) method. It may additionally or alternatively be the case that at least one layer encompassed by the coating is applied by vapor deposition (thermal evaporation) or a PVD (physical vapor deposition) method. It is alternatively or additionally conceivable that at least one layer encompassed by the coating is applied by sputtering and/or atomic layer deposition. In the context of the invention, layer generation by evaporation or a PVD method has been found to be particularly advantageous, since this can achieve particularly cost-and time-efficient layer generation. Furthermore, the benefit is manifested that an inventive combination of different high refractive index materials, even in the case of exclusive layer generation by evaporation, can achieve a coating with particularly high-quality optical properties, in particular high reflectance and/or low absorptivity.

It is further conceivable in the context of the invention that the applying of at least one layer encompassed by the coating by evaporation is additionally ion-and/or plasma-assisted. It is conceivable in particular that at least all layers of a first high refractive index material and/or at least all layers of a first low refractive index material and/or at least all layers of a first layer stack are vapor-deposited with ion and/or plasma assistance. Alternatively or additionally, it is conceivable that at least all layers of a second high refractive index material and/or at least all layers of a second low refractive index material and/or at least all layers of a second layer stack are vapor-deposited without ion and/or plasma assistance. In this way, it has been found in the context of the invention that a particularly low-absorption, broadband, low-scatter and at the same time highly reflective coating can be generated.

It is also conceivable that at least steps a) and b) are repeated, in particular prior to the first performance of step c) and/or d), for construction of a first layer stack, in particular in alternation, such that the layers of the first high refractive index material and the layers of the first low refractive index material are in an alternating arrangement in the first layer stack. It may additionally or alternatively be the case within the scope of the invention that steps a) and b) are performed the same number of times, such that the number of layers of the first high refractive index material in the first layer stack is equal to the number of layers of the first low refractive index material in the first layer stack.

In the context of the invention, it is optionally possible that steps c) and d) are repeated, in particular after performance of steps a) and/or b), for construction of a second layer stack, in particular in alternation, such that the layers of the second high refractive index material and the layers of the second low refractive index material are in an alternating arrangement in the second layer stack. It may additionally or alternatively be the case within the scope of the invention that steps c) and d) are performed the same number of times, such that the number of layers of the second high refractive index material in the first layer stack is equal to the number of layers of the second low refractive index material in the second layer stack. It may also be the case within the scope of the invention that at least one layer of the first high refractive index material and/or at least one layer of the second high refractive index material is applied at a temperature of 200° C. to 350° C., preferably 200° C. to 250° C., and/or at a coat rate of 0.1 nm/s to 1 nm/s, preferably 0.2 nm/s to 0.4 nm/s. This gives rise to the benefit of time-efficient and at the same time high-quality layer generation.

With regard to the present invention, it is conceivable that at least one layer of the first low refractive index material and/or at least one layer of the second low refractive index material is applied at a temperature of 200° C. to 350° C., preferably 200° C. to 250° C., and/or at a coat rate of 0.2 nm/s to 2 nm/s, preferably 0.2 nm/s to 0.5 nm/s. This gives rise to the benefit of time-efficient and at the same time high-quality layer generation.

It may further be the case within the scope of the invention that a method of the invention is designed for production of a coating of a device of the invention, in particular a device as claimed in any of claims 1 to 9.

Further advantages, features and details of the invention will be apparent from the description that follows, in which several working examples of the invention are described specifically with reference to the drawings. It may be the case here that the features mentioned in the claims and in the description are essential to the invention individually or in any combination. The figures show:

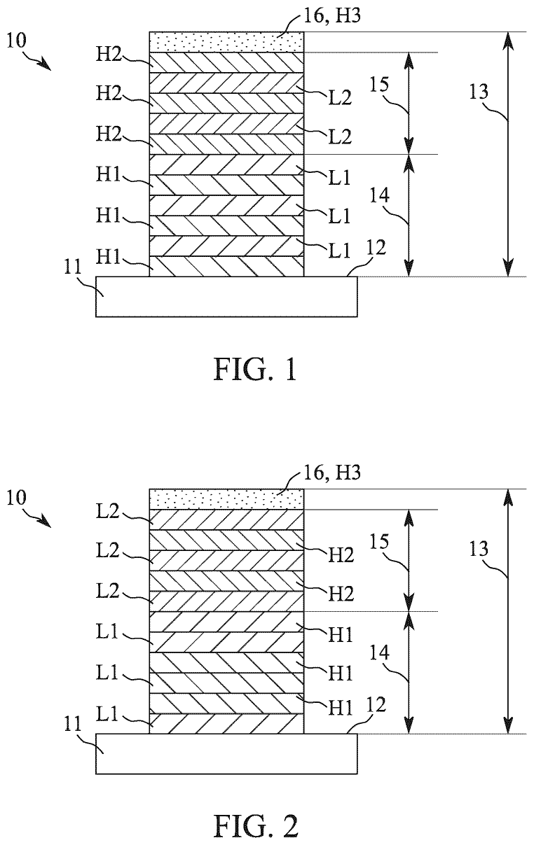

FIG. 1 a schematic diagram of an apparatus of the invention,

FIG. 2 a schematic diagram of an apparatus of the invention,

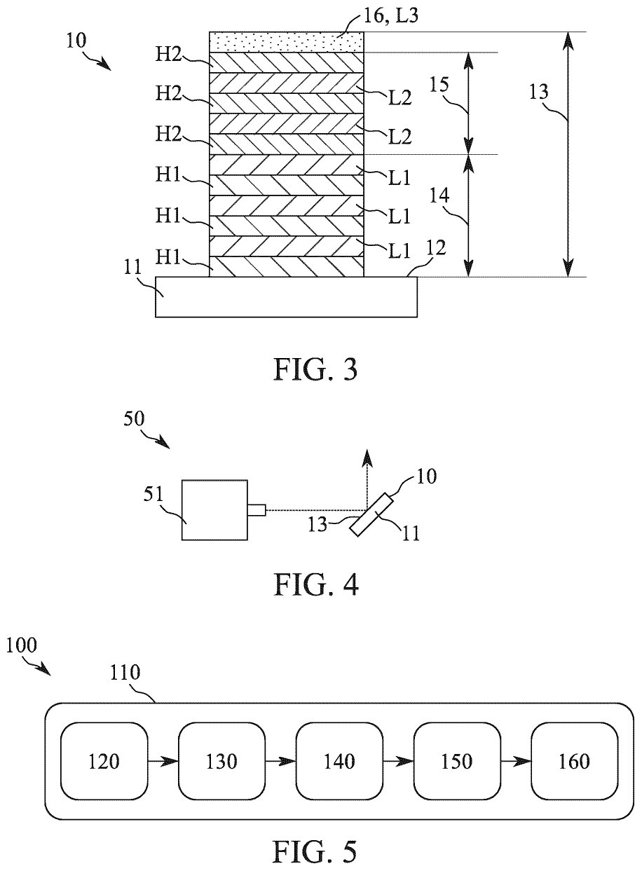

FIG. 3 a schematic diagram of an apparatus of the invention,

FIG. 4 a schematic diagram of a system of the invention and

FIG. 5 a schematic diagram of a method of the invention.

FIG. 1 shows a schematic diagram of an inventive device 10 for at least partial reflection of electromagnetic radiation. The device 10 comprises a base element 11, where a coating 13 is disposed at least in sections of a surface 12 of the base element 11. The coating 13 further comprises at least one layer H1 of a first high refractive index material and at least one layer H2 of a second high refractive index material, where the first high refractive index material is different than the second high refractive index material. In the present case, the first high refractive index material has a higher refractive index than the second high refractive index material, where the difference between the refractive indices is at least 0.1. Such a difference in refractive indices resulted in particularly advantageous properties of the coating 13 in the context of the present invention.

Both the at least one layer H1 of a first high refractive index material and the at least one layer H2 of a second high refractive index material are part of each layer stack 14, 15. In this case, the at least one layer H1 of a first high refractive index material is part of a first layer stack 14 and the layer H2 of a second high refractive index material is part of a second layer stack 15.

According to FIG. 1, the coating 13 comprises a first layer stack 14 and a second layer stack 15. The first layer stack 14 comprises at least one layer H1 of the first high refractive index material and at least one layer L1 of a first low refractive index material. In the present context, the first layer stack 14 comprises three layers H1, L1 each of the first high refractive index material and first low refractive index material. The lowermost layer H1 of the first layer stack 14 proceeding from the surface 12 of the base element 11, disposed atop the surface 12 of the base element 11, is formed from the first high refractive index material. It can also be inferred from FIG. 1 that the layers H1 of the first high refractive index material and the layers L1 of the first low refractive index material are in an alternating arrangement in the first layer stack 14.

According to FIG. 1, it is also the case that the second layer stack 15 comprises at least one layer H2 of the second high refractive index material and at least one layer L2 of a second low refractive index material. In the present context, the second layer stack 15 comprises three layers H2 of the second high refractive index material and two layers L2 of the second low refractive index material. It can also be inferred from FIG. 1 that the layers H2 of the second high refractive index material and the layers L2 of the second low refractive index material are in an alternating arrangement in the second layer stack 15.

The lowermost layer H2 of the second layer stack 15 proceeding from the surface 12 of the base element 11 is formed from the second high refractive index material and disposed on the uppermost layer L1 of the first layer stack 14 proceeding from the surface 12 of the base element 11, which is formed from the first low refractive index material. An alternating arrangement of high refractive index and low refractive index materials is thus maintained even at a transition between the first layer stack 14 and the second layer stack 15. In this way, it has been found that it was possible to achieve a particularly advantageous coating 13 with regard to the optical properties of the device, in particular with regard to high reflectivity and low absorptivity.

In the present context, the first layer stack 14 has greater absorptivity than the second layer stack 15. This has been found to be advantageous in terms of the generation of a highly reflective and at the same time low-absorption coating 13.

It can also be inferred from FIG. 1 that the coating 13 comprises a layer H3 of a third high refractive index material as outer layer 16. Alternatively, the outer layer 16 could also be formed from a third low refractive index material. Such a working example is shown in FIG. 3. The outer layer 16 forms the outermost layer of the coating 13 with respect to the surface 12 of the base element 11 and is disposed on the outermost layer of the second layer stack 15 with respect to the surface 12 of the base element 11. Since the second layer stack 15 ends in the direction of the outer layer 16 with a layer H2 of the second high refractive index material and the outer layer 16 in the present context is formed from a third high refractive index material, an alternating arrangement of high refractive index and low refractive index materials is interrupted at the transition between the outer layer 16 and the second layer stack 15. This showed the benefit of a high reflection and low absorption of a coating 13.

FIG. 2 likewise shows a schematic diagram of an inventive device 10, the basic structure of which corresponds to the device 10 shown in FIG. 1. However, the first layer stack 14 proceeds from the surface 12 of the base element 11 with a layer L1 of a first low refractive index material. At a transition between the first layer stack 14 and the second layer stack 15, an alternating arrangement of high refractive index and low refractive index materials is maintained. The outer layer 16, as in FIG. 1, is formed as a layer H3 of a third high refractive index material. At the transition between the second layer stack 15 and the outer layer 16, however, because of the altered structure of the coating 13 compared to FIG. 1, an alternating sequence of high and low refractive index materials is likewise maintained.

With regard to FIGS. 1 to 3, all layers H1, L1, H2, L2, H3, L3 encompassed by the coating 13 were applied by vapor deposition. This enables particularly cost-and time-efficient layer generation. Furthermore, the benefit is manifested that an inventive combination of different high refractive index materials, even in the case of exclusive layer generation by evaporation, can achieve a coating 13 with particularly high-quality optical properties, in particular high reflectance and/or low absorptivity. With regard to FIGS. 1 to 3, the vapor deposition of all layers H1, L1 of the first layer stack 14 was additionally ion-and/or plasma-assisted. All the other layers H2, L2, H3, L3 of the coating 13 were generated without ion and/or plasma assistance.

FIG. 4 shows a schematic diagram of an inventive system 50. The system 50 comprises at least one inventive device 10 for at least partial reflection of electromagnetic radiation and also at least one emission unit 51 for emission of electromagnetic radiation. In the present context, the emission unit 51 is designed for emission of electromagnetic radiation in the near-infrared region. The electromagnetic radiation is shown schematically by the dashed line in FIG. 4. The emission unit 51 is arranged relative to the device 10 in such a way that the electromagnetic radiation emitted by the emission unit 51 at least partly hits the coating 13 of the device 10. In the present context, the electromagnetic radiation hits the coating 13 of the device 10 at an angle of 45°.

In addition, FIG. 5 shows a schematic diagram of an inventive method 100 of producing an inventive device 10 for at least partial reflection of electromagnetic radiation. The method 100 comprises applying 110 a coating 13 to a base element 11 of the device 10, wherein the coating 13 is applied 110 by also performing at least the following steps:
a) applying 120 a layer H1 of a first high refractive index material, where the first high refractive index material is preferably a material from the group of Al2O3, HfO2, Y2O3, Sc2O3, CeO2, Ta2O5, Nb2O5, ZrO2, TiO2, SiO2:Al2O3, ZrO2:HfO2, Si, SiN, SiO, in particular in that the first high refractive index material is Ta2O5, TiO2, Nb2O5 or CeO2,
b) applying 130 at least one layer L1 of a first low refractive index material, where the first low refractive index material is preferably a material from the group of SiO2, SiO2:Al2O3, nanoporous SiO2, MgF2, AlF3, Na3AlF6, wherein the first low refractive index material is in particular SiO2,
c) applying 140 a layer H2 of a second high refractive index material, where the second high refractive index material is a material from the group of Al2O3, HfO2, Y2O3, Sc2O3, CeO2, Ta2O5, Nb2O5, ZrO2, TiO2, SiO2:Al2O3, ZrO2:HfO2, Si, SiN, SiO, in particular in that the second high refractive index material is HfO2, ZrO2 or ZrO2:HfO2,
d) applying 150 at least one layer L2 of a second low refractive index material, where the second low refractive index material is preferably a material from the group of SiO2, SiO2:Al2O3, nanoporous SiO2, MgF2, AlF3, Na3AlF6, wherein the second low refractive index material is in particular SiO2.
e) applying 160 a layer H3 of a third high refractive index material as outer layer 16, where, in particular, the third high refractive index material is the same as the second high refractive index material, or applying 160 a layer L3 of a third low refractive index material as outer layer 16, where, in particular, the third low refractive index material is the same as the second low refractive index material,
   wherein the first high refractive index material is different than the second high refractive index material and wherein, in particular, the first high refractive index material has a greater refractive index than the second high refractive index material.

### LIST OF REFERENCE SIGNS

10 device
11 base element
12 surface
13 coating
14 first layer stack
15 second layer stack
16 outer layer
50 system
51 emission unit
100 method
110 applying
120 applying
130 applying
140 applying
150 applying
160 applying
H1 layer
L1 layer
H2 layer
L2 layer
H3 layer
L3 layer

1. A device for at least partial reflection of electromagnetic radiation, the device comprising:
at least one base element; and
a coating disposed in at least sections of at least one surface of the base element, wherein the coating comprises at least one layer of a first high refractive index material and at least one layer of a second high refractive index material, and wherein the first high refractive index material is different than the second high refractive index material.

2. The device as claimed in claim 1, wherein the first high refractive index material has a greater refractive index than the second high refractive index material, where, in particular, the difference between the refractive index of the first high refractive index material and the refractive index of the second high refractive index material is at least 0.1.

3. The device as claimed in claim 1, wherein in that at least one layer encompassed by the coating has been generated by vapor deposition, sputtering and/or atomic layer deposition, where the vapor deposition of at least one layer has preferably additionally been ion-and/or plasma-assisted.

4. The device as claimed in claim 1, wherein in that the coating comprises at least one first layer stack the first layer stack comprising at least one layer of the first high refractive index material and at least one layer of a first low refractive index material, where, in particular, the layers of the first high refractive index material and the layers of the first low refractive index material are in an alternating arrangement.

5. The device as claimed in claim 1, wherein in that the coating has at least one second layer stack the second least one layer of a second low refractive index material, where, in particular, the layers of the second high refractive index material and the layers of the second low refractive index material are in an alternating arrangement.

6. The device as claimed in claim 1, wherein in that the coating comprises a layer of a third high refractive index material as outer layer where, in particular, the third high refractive index material is the same as the second high refractive index material, or in that the coating comprises a layer of a third low refractive index material as outer layer where, in particular, the third low refractive index material is the same as the second low refractive index material.

7. The device as claimed in claim 1, wherein the first high refractive index material and/or the second high refractive index material is a material from the group of Al2O3, HfO2, Y2O3, Sc2O3, CeO2, Ta2O5, Nb2O5, ZrO2, TiO2, SiO2:Al2O3, ZrO2:HfO2, Si, SiN, SiO, in particular in that the first high refractive index material is Ta2O5, TiO2, Nb2O5 or CeO2 and/or the second high refractive index material is HfO2, and/or in that the first low refractive index material and/or the second low refractive index material is a material from the group of SiO2, SiO2:Al2O3, nanoporous SiO2, MgF2, AlF3, Na3AlF6, in particular in that the first low refractive index material is SiO2 and/or in that the second low refractive index material is SiO2.

8. The device as claimed in claim 1, wherein at least one layer encompassed by the coating takes the form of a quarter-wave layer in relation to a wavelength in the range of 300 nm to 3000 nm, in particular in the range of 900 nm to 1500 nm.

9. The device as claimed in claim 1, wherein the coating in relation to incident electromagnetic radiation has a reflectance of at least 98%, in particular at least 99%, preferably at least 99.5%, more preferably at least 99.9%, and/or an absorptivity of less than 20 ppm, in particular less than 10 less than 2 ppm, more preferably less than 1.5 ppm.

10. A system comprising at least one device for at least partial reflection of electromagnetic radiation as claimed in claim 1 and at least one emission unit for emission of electromagnetic radiation, in particular electromagnetic radiation in the near-infrared region, wherein, in particular, the emission unit is arranged relative to the device such that the electromagnetic radiation emitted by the emission unit at least partly hits the coating of the device preferably at an angle between 0° and 45°.

11. A method of producing a device for at least partial reflection of electromagnetic radiation, in particular as claimed in claim 1, the method comprising:
applying a coating to a base element of the device wherein applying of the coating is accomplished in that at least the following steps are also performed, especially in the sequence specified:
a) applying a layer of a first high refractive index material, where the first high refractive index material is preferably a material from the group of Al2O3, HfO2, Y2O3, Sc2O3, CeO2, Ta2O5, Nb2O5, ZrO2, TiO2, SiO2:Al2O3, ZrO2:HfO2, Si, SiN, SiO, in particular in that the first high refractive index material is Ta2O5, TiO2, Nb2O5 or CeO2,
c) applying a layer of a second high refractive index material, where the second high refractive index material is a material from the group of Al2O3, HfO2, Y2O3, Sc2O3, CeO2, Ta2O5, Nb2O5, ZrO2, TiO2, SiO2:Al2O3, ZrO2:HfO2, Si, SiN, SiO, in particular in that the second high refractive index material is HfO2, ZrO2 or ZrO2:HfO2,
wherein the first high refractive index material is different than the second high refractive index material and wherein, in particular, the first high refractive index material has a greater refractive index than the second high refractive index material.

12. The method as claimed in claim 11, wherein addition, in particular after step a), at least the following step is performed: b) applying at least one layer of a first low refractive index material, where the first low refractive index material is preferably a material from the group of SiO2, SiO2:Al2O3, nanoporous SiO2, MgF2, AlF3, Na3AlF6, wherein the first low refractive index material is in particular SiO2, and/or in that, in addition, in particular after step c), at least the following step is performed:
d) applying at least one layer of a second low refractive index material, where the second low refractive index material is preferably a material from the group of SiO2, SiO2:Al2O3, nanoporous SiO2, MgF2, AlF3, Na3AlF6, wherein the second low refractive index material is in particular SiO2.

13. The method as claimed in claim 11, wherein in addition, in particular after step d), at least the following step is performed:
e) applying a layer of a third high refractive index material as outer layer where, in particular, the third high refractive index material is the same as the second high refractive index material, or applying a layer of a third low refractive index material as outer layer where, in particular, the third low refractive index material is the same as the second low refractive index material.

14. The method as claimed in claim 11, wherein at least one layer encompassed by the coating is applied by vapor deposition, sputtering and/or atomic layer deposition, where the vapor deposition of at least one layer has preferably additionally been ion-and/or plasma-assisted.

15. The method as claimed in claim 11, wherein at least steps a) and b) are repeated, in particular prior to the first performance of step c) and/or d), for construction of a first layer stack in particular in alternation, such that the layers of the first high refractive index material and the layers of the first low refractive index material are in an alternating arrangement in the first layer stack and/or in that steps c) and d) are repeated, in particular after performance of steps a) and/or b), for construction of a second layer stack in particular in alternation, such that the layers of the second high refractive index material and the layers of the second low refractive index material are in an alternating arrangement in the second layer stack.

16. The method as claimed in claim 11, wherein at least one layer of the first high refractive index material and/or at least one layer of the second high refractive index material is applied at a temperature of 200° C. to 350° C. and/or at a coat rate of 0.1 nm/s to 1 nm/s and/or in that at least one layer of the first low refractive index material and/or at least one layer of the second low refractive index material is applied at a temperature of 200° C. to 350° C. and/or at a coat rate of 0.2 nm/s to 2 nm/s.
